(19) United States
(12) Patent Application Publication
(10) Pub. No.: US 2005/0211280 A1
(43) Pub. Date: Sep. 29, 2005

(54) Multifunction vehicular surface cleaning system

(76) Inventor: David Liu, Taipei (TW)

Correspondence Address: CHARLES E. BAXLEY, ESQ., 90 JOHN STREET, THIRD FLOOR, NEW YORK, NY, 10038, US

(21) Appl. No.: 10/809,746

(22) Filed: Mar. 25, 2004

(51) Int. Cl. B08B 3/02

(52) U.S. Cl. 134/95.1; 134/123; 134/198; 134/98.1; 134/103.2

(57) ABSTRACT

The present invention provides a multifunction vehicular surface cleaning system comprised of pipe, soap box and switcher; wherein, said soap box is located on the outside of said pipe at the inlet end of the pipe with the its outlet; said switcher is correspondently set upon the outlet of the soap box and the inlet of the pipe, so that by turning said switcher the system can be shifted in cut-off said input pipe with soap box and output pipe, or cut-in the input pipe to output pipe directly only, or cut-in the input pipe to both the output pipe and the soap box, in order to carry out three working states of cut-off, or spraying clear water or soap water. A hollow brush is connected to the outlet of output pipe in socket joint, and there are some water gates built on bottom base of the brush for facilitating to cleaning operation directly. Said cleaning system is very convenient in shifting operation as changing functions, meanwhile the leak tightness is good, the cleaning operation is also convenient.

### BACKGROUND OF THE INVENTION

1. Field of the Invention

The present invention relates to a multifunction vehicular surface cleaning system, and more especially to a cleaning system having three working states-cut-off, clear water or soap water shifted by turning a knob, so as to facilitating to clean vehicular surfaces.

2. Description of Prior Art

In accordance with the conventional multifunction car cleaning systems, several multifunction car cleaning guns released by Chinese Patent No.: 99244565.5, as shown in FIG. 1 to FIG. 3, typically comprise of soap box 1′ (1″), pipe 2′ (2″) and switcher. In use, by shifting said switcher the gun is working in spraying clear water or soap water state from the front end of said pipe 2′ (2″) to the car's surface, and meanwhile by taking the advantage of other cleaning tools (for example wiper) the car is treated in cleaning process for meeting to cleaning the vehicle surface goal, but there are too many cleaning tools used alternately in cleaning process, so it brings the cleaning work up to inconvenience; additionally, whether by a multifunction switcher (as shown in FIG. 2 and FIG. 3), or sliding said soap box 1′ relatively to said pipe 2′ (as shown in FIG. 1) to carry out cut-off, spraying clear water or soap water, the seal ring 3′ is easy to be worn out so that leak can not be avoided, or by turning a knob 4″ located in one side of said pipe 2″ to bring said soap box 1″ located on one side of said pipe 2″ up to turn so as to carry out shifting functions (as shown in FIG. 2 and FIG. 3), in this way the shifting operation is not easy and convenient, so it is necessary to innovate on the mechanisms of the conventional vehicle cleaning system.

### OBJECTS AND SUMMARY OF THE INVENTION

It is therefore a main object of the present invention to provide a multifunction vehicular surface cleaning system, in which the shifting operation is easy and convenient, and its leak tightness is good.

It is a next object of the present invention to provide a multifunction vehicular surface cleaning system, which is facilitated to cleaning operation.

For archiving said goals, the present invention provides the resolution being to build a multifunction cleaning system, which is comprised pipe, soap box and switcher; wherein, said soap box is located on the outside of said pipe at the inlet end of the pipe with the its outlet; said switcher is correspondently set upon the outlet of the soap box and the inlet of the pipe, so that by turning said switcher the system can be shifted in cut-off said input pipe with soap box and output pipe, or cut-in the input pipe to output pipe directly only, or cut-in the input pipe to both the output pipe and the soap box, in order to carry out three working states of cut-off, or spraying clear water or soap water; said switcher is typically comprised of valve, baffle, rotating switcher and seal rings, therein the valve has an eccentric pocket connecting with the output pipe throughout, coordinating to the eccentric pocket of the valve said baffle has a water hole built up for connecting to the eccentric pocket as turning in a proper position, said rotating switcher has a through-hole set upon for connecting the water hole of the baffle to the inlet of said pipe throughout, and a by-pass hole for connecting to the outlet of the soap box as turned in a proper position; for preventing leaking, proper number of seal rings are set up between all touching components.

Said soap box extends out a mounting base from the front outside end for placing the switcher in, said switcher is mounted in the base and located by a retainer; a shifting lever making the valve, the baffle and the rotating switcher turn extended out from a notching slot of said base of the soap box for facilitating to shifting operation, and also mount a knob on said base so that the extended end of the shifting lever is inserted into said knob, by turning the knob the shifting lever can make the valve, the baffle and the switcher turn relatively. And there is an inlet of soap liquid built upon the side of said soap box for adding soap liquid and sealed by securing a cap.

Said baffle of the switcher assembly has a central hole built on for fitting in a sealed connection shaft downward; said connection shaft is separately fastened on the valve and the rotating switcher with two proper ends so that said valve and the rotating switcher can be simultaneously turned. So when sliding the shifting lever fixed on said rotating switcher, said valve and the rotating switcher can be turned simultaneously.

Said valve of the switcher assembly has a T-shaped section crossly, in which the vertical bar is said connection shaft; the top end of said connection shaft is fit into the central hole of the baffle and sealed with a seal ring on the joint portion, and the another end is fastened on the rotating switcher so that the valve and the rotating switcher can be moved simultaneously. Said connection shaft has a flat bottom end, coordinating to the flat end of the connection shaft, the rotating switcher has a retaining slot for holding the flat bottom end of the connection shaft.

Said baffle has an H-shaped cross-section, which is sandwiched by the valve and the rotating switcher so as to decrease the volume of the whole switcher, and facilitate to assemble; for preventing the baffle from turning in the mounting base, the baffle is embedded into said base axially with the lug set upon the outside of the baffle sliding and fitting into the axial slot on the inside wall of the base.

A multifunction vehicular surface cleaning system is typically comprised of pipe, soap box and switcher; wherein, a hollow brush is connected to the outlet of output pipe in socket joint, and there are some water gates on bottom base of the brush for facilitating to cleaning operation directly.

Since applying above-mentioned system, the present invention is designed into attach the soap box and switcher on the pipe axially so that the number of the components is reduced, and the mechanism is simplified; in using, directly slide or by turning the knob to shift the shifting lever to rotate the valve, the baffle and the rotating switcher, so that the relative positions between the valve, the baffle and the rotating switcher are changed; when the eccentric pocket of the valve is moved away from the water hole of the baffle, the water led by the input pipe and the eccentric pocket of the valve is blocked by the baffle, the whole cleaning system is in cut-off state; when the eccentric pocket of the valve is moved to align the water hole of the baffle, meanwhile communication the input pipe and the through-hole of the rotating switcher and the inlet of the pipe, and the by-pass hole is not aligned to the outlet of the soap box—the outlet of the soap box is cut off, water passes through the input pipe, the eccentric pocket of the valve, the water hole of the baffle, the through-hole of the rotating switcher and the inlet of the pipe, and flows out from the outlet of the pipe, so the whole cleaning system is working in clear water washing state; when the eccentric pocket of the valve is moved to align the water hole of the baffle, meanwhile communication the input pipe and the through-hole of the rotating switcher and the inlet of the pipe, as the by-pass hole is turned to align with the outlet of the soap box—the outlet of the soap box is cut in the flowing way of water, water passes through the input pipe, the eccentric pocket of the valve and the through-hole of the baffle, meanwhile a bit stream of water enters to the soap box via the by-pass hole of the rotating switcher and the outlet of the soap box, and mix with the soap liquid, then the soap liquid is pressed out from the outlet of the soap box, passing through said by-pass hole of the rotating switcher to mix with water to compose soap detergent for washing vehicular surface. Said cleaning system is very convenient in shifting operation as changing functions, and in using sealing rings are not moved any more, so the wear is very little, and leakage is avoided, and the leak tightness is kept in good condition.

### BRIEF DESCRIPTION OF THE DRAWINGS

FIG. 1 is a cross-section view of the first prior art.

FIG. 2 is a cross-section view of the second prior art.

FIG. 3 is a cross-section view of the third prior art.

FIG. 4 is an exploded view of the present invention.

FIG. 5 is a sectional solid view showing the cut-off state of the present invention.

FIG. 6 is a sectional solid view showing the clear water washing state of the present invention.

FIG. 7 is a sectional solid view showing the soap water washing state of the present invention.

FIG. 8 is an external view showing the whole body of the present invention.

FIG. 9 is a cross-section view showing the whole body of the present invention.

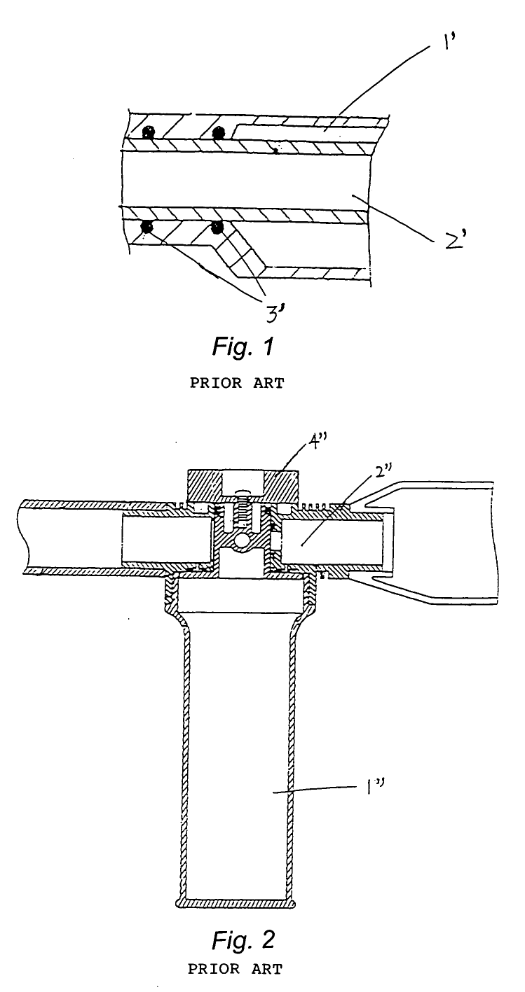

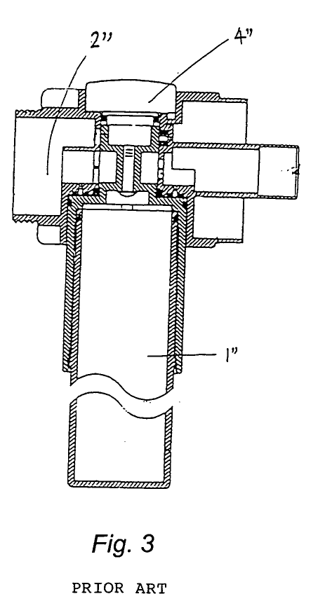

### DETAILED DESCRIPTION OF PREFERRED EMBODIMENTS

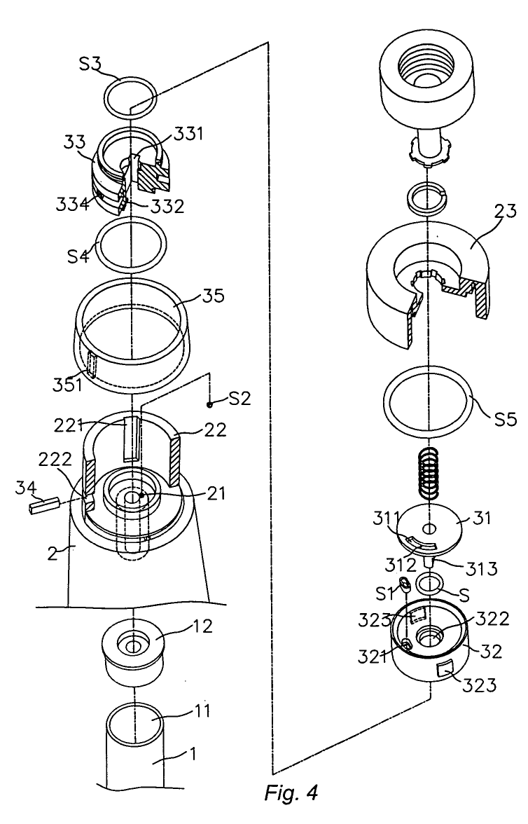

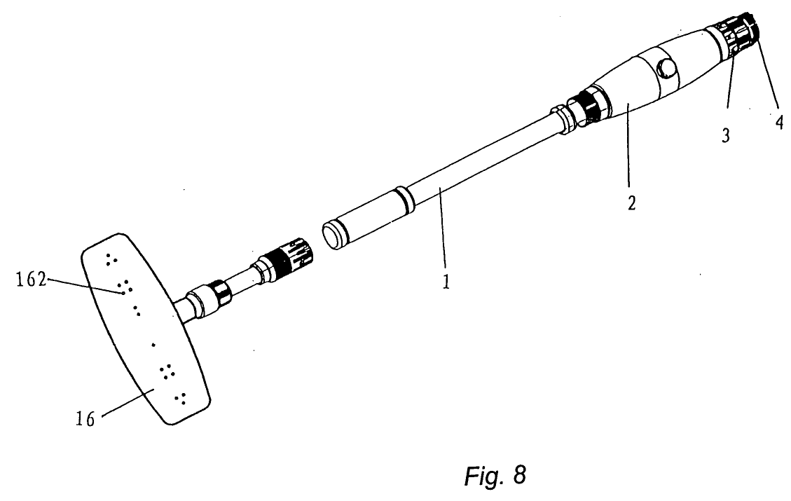

Referring to FIG. 4, cooperating to refer to FIG. 8, the present invention provides a multifunction vehicular surface cleaning system comprised of pipe 1, soap box 2 and switcher 3. Wherein, said soap box 2 is located on the outside of said pipe 1 so that its outlet 21 approaches the inlet 11 end of the pipe 1. The fastening way of locating the soap box 2 on the pipe 1 can be in different type mechanism, it, as shown in FIG. 4 and FIG. 8, can be to insert the pipe 1 into the hollow inside of the soap box 2 through, by means of glue 12, a seal ring 13 and a nut 14, the pipe 1 is located at the inside of the soap box 2; in the other way, for convenient to fastening the pipe 1 into the inside of the soap box 2, said soap box 2 can be manufactured into two half bodies, and glued on the outside of the pipe 1, in this case, as combination, one half soap box should be fastened on the one side of the pipe 1 with glue 12, then the another half soap box is fixed on by thermosetting or by ultrasonic bond to assemble seal ring 13 and nut 14 to combine a whole assembly.

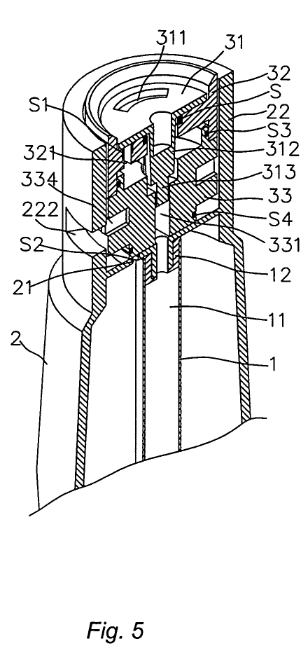

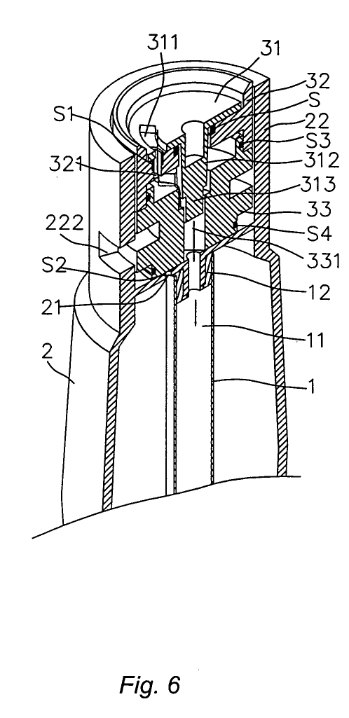

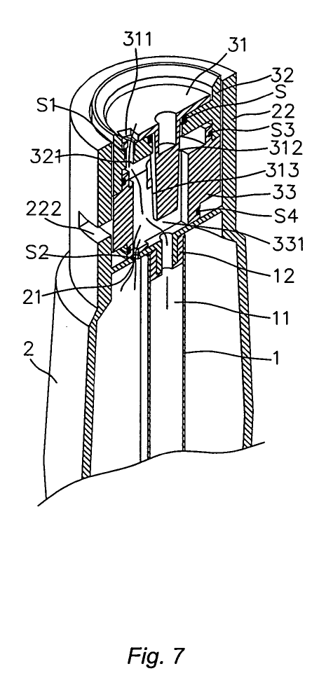

Said switcher 3 is correspondently set upon the outlet 21 of the soap box 2 and the inlet 11 of the pipe 1, and located between the pipe 1, the soap box 2 and the input pipe 4, and two seal rings S2 S5 are separately located on the joint portions between the switcher 3 with the soap box 2 and the input pipe 4 for improving the leak tightness and facilitating to the combination; said soap box 2 extends out a mounting base 22 from the front outside end for placing the switcher 3 in, said switcher 3 assembly (including a valve 31, a baffle 32, a rotating switcher 33 and several seal rings S S1 S2 and so on) is mounted in the base 22 and located by securing the external thread of a retainer 23 on the internal thread of the base 22; by turning said switcher 3 the system can be shifted in cut-off said input pipe 4 with soap box 2 and the pipe 1 (as shown in FIG. 5), or cut-in the input pipe 4 to the pipe 1 directly only (as shown in FIG. 6), or cut-in the input pipe 4 to both the pipe 1 and the soap box 2 (as shown in FIG. 7), in order to carry out three working states of cut-off, or spraying clear water or soap water.

Wherein, said switcher 3 is typically comprised of a valve 31, a baffle 32, a rotating switcher 33 and several seal rings S S1 S2 S3 and so on, by means of the pressing force coming from a spring set on between the tip end of the input pipe 4 and the valve 31, and the seal rings S S1 S2 S3, the all parts of said switcher 3 are kept in tightly contact with a good leak tightness (as shown in FIG. 8).

The valve 31 has a T-shaped section crossly in typical design, therein an eccentric pocket 311 is built on connecting with the input pipe 4 throughout, in which the vertical bar of the T-shaped valve 31 is a connection shaft 312; the top end of said connection shaft 312 is fit into the central hole 322 of the baffle 32 and sealed with a seal ring S on the joint portion, and the another end is fastened on the rotating switcher 33 so that the valve 31 and the rotating switcher 33 can be moved simultaneously, the fastening method can be selected in many types, in this embodiment, said connection shaft 312 has a flat bottom end 313, coordinating to the flat end 313 of the connection shaft 312, the rotating switcher 33 has a retaining slot 333 for holding the flat bottom end 313 of the connection shaft 312 so as to be moved with said valve 32 simultaneously.

Said baffle 32 has an H-shaped cross-section, which is sandwiched by the valve 31 and the rotating switcher 33 so as to decrease the volume of the whole switcher, and facilitate to assemble; coordinating to the eccentric pocket 311 of the valve 31 said baffle 32 has a water hole 321 built up for connecting to the eccentric pocket 311 as turning in a proper position, between the contacting faces of said water hole 321 and said valve 31 there is a seal ring S1 set upon for sealing. Said baffle 32 has a central hole 322 built on for fitting in a sealed connection shaft 312 downward (as mentioned before), for preventing the baffle 32 from turning in the mounting base 22, the baffle 32 is embedded into said base axially with the lug 323 set upon the outside of the baffle 32 sliding and fitting into the axial slot 221 on the inside wall of the base 22.

Said rotating switcher 33 typically designed into a block has a through-hole 331 set upon for connecting the water hole 321 of the baffle 32 to the inlet 11 of said pipe 1 throughout, and a by-pass hole 332 for connecting to the outlet 21 of the soap box 2 as turned in a proper position; on the tip side of said through-hole 331 there is a retaining slot 333 built upon for holding the bottom end of the connection shaft 312 so as to be moved with said valve 32 simultaneously; between the by-pass hole 332 and the outlet 21 a seal ring S2 is set upon the contacting surfaces for improving leak tightness; for the same sake, a seal ring S3 is set upon the contacting surfaces of the outside of the rotating switcher 33 and the baffle 32. said rotating switcher 33 has a slot 334 built on the side for holding the end of the shifting lever 34, the another end of the shifting lever 34 is extended out passing through a notching slot of said base 22 to be fastened on the inside wall of a knob 35, which is put over the base 22, therefore as turning the knob 35 the shifting lever 34 can make the valve 31 and the rotating switcher 33 turn to facilitate to shift the three working states in cut-off, clean water and soap water washing state. A seal ring S4 is set on the contacting surfaces of the outside of the rotating switcher 33 and the inside of the base 22 for sealing.

All the contacting surfaces of all the parts of the present invention should be set upon with seal rings S S1 S2 S3 S4 or S5, the setting way of the seal rings and the number of them are not limited by the description, the mere goal is to avoid leaking water or liquid as normally shifting the switcher 3 in the three working states.

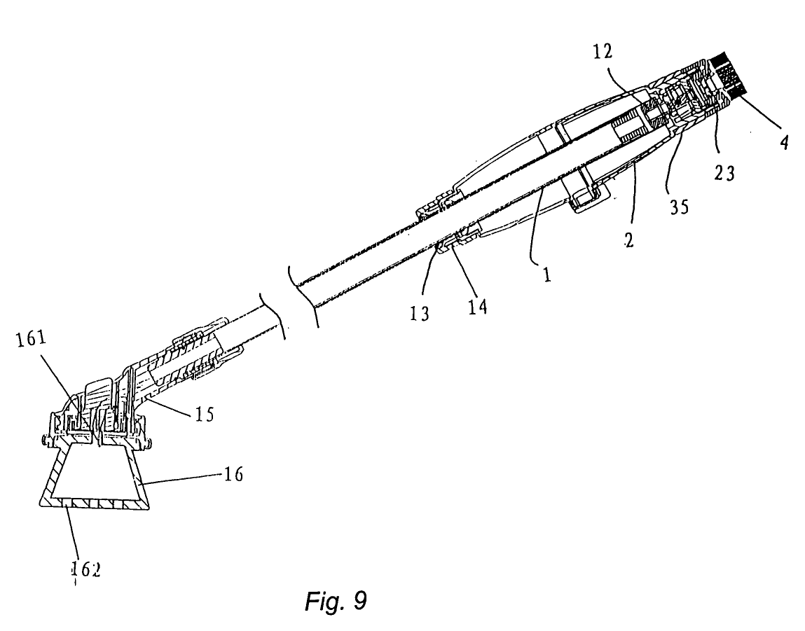

For facilitating to directly washing, and avoiding alternating several different washing tools, the present invention provides a hollow brush 16 connected to the outlet 15 of the output pipe 1 in socket joint, referring to FIG. 8 and FIG. 9, the brush 16 has a column of water gates 162 built on bottom base for facilitating to cleaning operation directly.

In this case, when using, by turning the knob 35 the shifting lever 34 can make the valve 31, the baffle 32 and the switcher 33 turn relatively.

As shown in FIG. 5, when the eccentric pocket 311 of the valve 31 is moved away from the water hole 321 of the baffle 32, the water led by the input pipe 4 and the eccentric pocket 311 of the valve 31 is blocked by the baffle 32, the whole cleaning system is in cut-off state.

Referring to FIG. 6, when the eccentric pocket 311 of the valve 31 is moved to align the water hole 321 of the baffle 32, meanwhile communication the input pipe 4 and the throughhole 331 of the rotating switcher 33 and the inlet 11 of the pipe 1, and the by-pass hole 332 is not aligned to the outlet 21 of the soap box 2—the outlet 21 of the soap box 2 is cut off, water passes through the input pipe 4, the eccentric pocket 311 of the valve 31, the water hole 321 of the baffle 32, the through-hole 331 of the rotating switcher 33 and the inlet 11 of the pipe 1, and flows out from the outlet 15 of the pipe 1, so the whole cleaning system is working in clear water washing state. When water enters the hollow brush 16 and via the water gates 162 on the bottom base, the water flows through the bristles to get the surface of vehicle for facilitating to directly cleaning with clear water.

Referring to FIG. 7, when the eccentric pocket 311 of the valve 31 is moved to align the water hole 321 of the baffle 32, meanwhile communication the input pipe 4 and the throughhole 331 of the rotating switcher 33 and the inlet 11 of the pipe 1, as the by-pass hole 332 is turned to align with the outlet 21 of the soap box 2—the outlet 21 of the soap box 2 is cut in the flowing way of water, water passes through the input pipe 4, the eccentric pocket 311 of the valve 31 and the through-hole 321 of the baffle 32, meanwhile a bit stream of water enters to the soap box 2 via the by-pass hole 332 of the rotating switcher 33 and the outlet 21 of the soap box 2, and mix with the soap liquid, then the soap liquid is pressed out from the outlet 21 of the soap box 2, passing through said by-pass hole 332 of the rotating switcher 33 to mix with water to compose soap detergent for washing vehicular surface. When water enters the hollow brush 16 and via the water gates 162 on the bottom base, the water flows through the bristles to get the surface of vehicle for facilitating to directly cleaning with clear water.

Said valve 31, the baffle 32 and the rotating switcher 33 can be designed in other shapes and mechanisms different from the embodiment of the present invention, for example, the connection shaft bring the valve 31 and the rotating switcher 33 to turn may be designed into individual part or integrate with the valve 31 or the rotating switcher 33; the shifting lever 34 may be more than one so that they can respectively control the valve 31, the baffle 32 and the rotating switcher 33, and so on.

The key feather of the present invention is to put the soap box 2 and the switcher 3 on the pipe 1 axially, by directly or indirectly turning the switcher 3, the relative positions of the valve 31, the baffle 32 and the rotating switcher 33 are changed, so that the cleaning system is shifted in three working states—cut-off, clear water and soap water washing states.

1. A multifunction vehicular surface cleaning system comprised of pipe, soap box and switcher; wherein, said soap box is located on the outside of said pipe at the inlet end of the pipe with the its outlet; said switcher is correspondently set upon the outlet of the soap box and the inlet of the pipe, so that by turning said switcher the system can be shifted in cut-off said input pipe with soap box and output pipe, or cut-in the input pipe to output pipe directly only, or cut-in the input pipe to both the output pipe and the soap box, in order to carry out three working states of cut-off, or spraying clear water or soap water; said switcher is typically comprised of valve, baffle, rotating switcher and seal rings, therein the valve has an eccentric pocket connecting with the output pipe throughout, coordinating to the eccentric pocket of the valve said baffle has a water hole built up for connecting to the eccentric pocket as turning in a proper position, said rotating switcher has a through-hole set upon for connecting the water hole of the baffle to the inlet of said pipe throughout, and a by-pass hole for connecting to the outlet of the soap box as turned in a proper position; for avoiding leaking, proper number of seal rings are set up between all touching components.

2. A multifunction vehicular surface cleaning system as claimed in claim 1, wherein, said soap box extends out a mounting base from the front outside end for placing the switcher in; said switcher is mounted in the base and located by a retainer.

3. A multifunction vehicular surface cleaning system as claimed in claim 2, wherein said a shifting lever making the valve, the baffle and the rotating switcher turn extended out from a notching slot of said base of the soap box for facilitating to shifting operation.

4. A multifunction vehicular surface cleaning system as claimed in claim 3, wherein a knob is mounted on said base so that the extended end of the shifting lever is inserted into said knob, by turning the knob the shifting lever can make the valve, the baffle and the switcher turn relatively.

5. A multifunction vehicular surface cleaning system as claimed in claim 1, wherein the baffle of the switcher has a central hole built on for fitting in a sealed connection shaft downward; said connection shaft is separately fastened on the valve and the rotating switcher with two proper ends so that said valve and the rotating switcher can be simultaneously turned.

6. A multifunction vehicular surface cleaning system as claimed in claim 5, wherein a shifting lever is mounted on the rotating switcher, when sliding the shifting lever fixed on said rotating switcher, said valve and the rotating switcher can be turned simultaneously.

7. A multifunction vehicular surface cleaning system as claimed in claim 5, wherein said valve of the switcher has a T-shaped section crossly, in which the vertical bar is said connection shaft; the top end of said connection shaft is fit into the central hole of the baffle and sealed with a seal ring on the joint portion, and the another end is fastened on the rotating switcher so that the valve and the rotating switcher can be moved simultaneously.

8. A multifunction vehicular surface cleaning system as claimed in claim 5, wherein said connection shaft has a flat bottom end, coordinating to the flat end of the connection shaft, the rotating switcher has a retaining slot for holding the flat bottom end of the connection shaft.

9. A multifunction vehicular surface cleaning system as claimed in claim 1, wherein said baffle has an H-shaped cross-section, which is sandwiched by the valve and the rotating switcher; the H-shaped baffle has a lug set upon the outside for sliding and fitting into the axial slot on the inside wall of the base.

10. A multifunction vehicular surface cleaning system is typically comprised of pipe, soap box and switcher; wherein, a hollow brush is connected to the outlet of output pipe in socket joint, and there are some water gates on bottom base of the brush for facilitating to cleaning operation directly.
